(19) United States
(12) Patent Application Publication
(10) Pub. No.: US 2011/0024651 A1
(43) Pub. Date: Feb. 3, 2011

(54) RADIATION SYSTEM AND METHOD, AND A SPECTRAL PURITY FILTER

(75) Inventors: Hendrikus Gijsbertus Schimmel, Utrecht (NL); Tjarko Adriaan Rudolf Van Empel, Eindhoven (DE); Gerardus Hubertus Petrus Maria Swinkels, Eindhoven (NL); Maarten Marinus Johannes Wilhelmus Van Herpen, Heesch (NL); Dzmitry Labetski, Eindhoven (NL)

Correspondence Address: PILLSBURY WINTHROP SHAW PITTMAN, LLP, P.O. BOX 10500, MCLEAN, VA, 22102, US

(73) Assignee: ASML NETHERLANDS B.V., VELDHOVEN (NL)

(21) Appl. No.: 12/741,978

(22) PCT Filed: Nov. 7, 2008
(86) PCT No.: PCT/NL08/50704

§ 371 Date: Oct. 18, 2010

Related U.S. Application Data
(60) Provisional application No. 60/996,280, filed on Nov. 8, 2007.

(51) Int. Cl. H05G 2/00; G21K 5/04; G02B 5/26; G02B 5/18

(52) U.S. Cl. 250/504 R; 250/503.1; 359/361

(57) ABSTRACT

A radiation system configured to generate a radiation beam, the radiation system including a chamber including: a radiation source configured to generate radiation; a radiation beam emission aperture; a radiation collector configured to collect radiation generated by the source, and to transmit the collected radiation to the radiation beam emission aperture; and a spectral purity filter configured to enhance a spectral purity of the radiation to be emitted via the aperture, wherein the spectral purity filter is configured to divide the chamber into a high pressure region and a low pressure region.

### CROSS-REFERENCE TO RELATED APPLICATIONS

This application claims the benefit of U.S. provisional application 60/996,280, which was filed on 8 Nov. 2007, and which is incorporated herein in its entirety by reference.

### FIELD

The present invention relates to a radiation system, a spectral purity filter and a method to provide a radiation beam.

### BACKGROUND

A lithographic apparatus is a machine that applies a desired pattern onto a substrate, usually onto a target portion of the substrate. A lithographic apparatus can be used, for example, in the manufacture of integrated circuits (ICs). In that instance, a patterning device, which is alternatively referred to as a mask or a reticle, may be used to generate a circuit pattern to be formed on an individual layer of the IC. This pattern can be transferred onto a target portion (e.g. including part of, one, or several dies) on a substrate (e.g. a silicon wafer). Transfer of the pattern is typically via imaging onto a layer of radiation-sensitive material (resist) provided on the substrate. In general, a single substrate will contain a network of adjacent target portions that are successively patterned.

Lithography is widely recognized as one of the key steps in the manufacture of ICs and other devices and/or structures. However, as the dimensions of features made using lithography become smaller, lithography is becoming a more critical factor for enabling miniature IC or other devices and/or structures to be manufactured.

A theoretical estimate of the limits of pattern printing can be given by the Rayleigh criterion for resolution as shown in equation (1):

$$CD = {k}_{1} * \frac{λ}{{NA}_{PS}} \qquad ( 1 )$$

where λ is the wavelength of the radiation used, NA_{PS} is the numerical aperture of the projection system used to print the pattern, k₁ is a process dependent adjustment factor, also called the Rayleigh constant, and CD is the feature size (or critical dimension) of the printed feature. It follows from equation (1) that reduction of the minimum printable size of features can be obtained in three ways: by shortening the exposure wavelength λ, by increasing the numerical aperture NA_{PS} or by decreasing the value of k₁.

In order to shorten the exposure wavelength and, thus, reduce the minimum printable size, it has been proposed to use an extreme ultraviolet (EUV) radiation source. EUV radiation sources are configured to output a radiation wavelength of about 13 nm. Thus, EUV radiation sources may constitute a significant step toward achieving small features printing. Such radiation is termed extreme ultraviolet or soft x-ray, and possible sources include, for example, laser-produced plasma sources, discharge plasma sources, or synchrotron radiation from electron storage rings.

US2006/0146414A1 discloses an apparatus including a source-collector-module, an illumination system and a projection system. The radiation unit is provided with a radiation source which may employ a gas or vapor, such as for example Xe gas or Li vapor in which a very hot discharge plasma is created so as to emit radiation in the EUV range of the electromagnetic radiation spectrum. The radiation emitted by the radiation source is passed from the source chamber into collector chamber via a gas barrier or “foil trap”. The collector chamber includes a radiation collector which is formed by a grazing incidence collector. Radiation passed by collector transmits through a spectral purity filter. The known filter includes an aperture, the aperture having a diameter, wherein the spectral purity filter is configured to enhance the spectral purity of a radiation beam by reflecting radiation of a first wavelength and allowing at least a portion of radiation of a second wavelength to transmit through the aperture, the first wavelength being larger than the second wavelength.

### SUMMARY

It is desirable to provide an improved radiation system. It is also desirable to provide a radiation system that can generate a spectrally sufficiently pure radiation beam to be used in lithography. It is also desirable to provide a durable radiation system that can generate a pure beam of extreme ultraviolet (EUV) radiation.

According to an embodiment there is provided a radiation system configured to generate a radiation beam, the system including a chamber including a radiation source configured to generate a radiation; a radiation beam emission aperture; a radiation collector configured to collect the radiation generated by the source, and to transmit the collected radiation to the radiation beam emission aperture; and a spectral purity filter configured to enhance a spectral purity of the radiation that is to be emitted via the aperture, wherein the filter is configured to divide the chamber into a high pressure region and a low pressure region.

According to a further embodiment, the radiation source can be configured to generate extreme ultraviolet radiation.

Preferably, the collector is included in or abuts the high pressure region, wherein the low pressure region is arranged between the spectral purity filter and the radiation emission aperture.

In yet a further embodiment, the collector is one or more of:
a collector configured to focus collected radiation into the radiation beam emission aperture;
a collector having a first focal point that coincides with the radiation source and a second focal point that coincides with the radiation beam emission aperture;
a normal incidence collector;
a collector having a single substantially ellipsoid radiation collecting surface section; and
a Schwarzschild collector having two radiation collecting surfaces.

Also, the system may comprise a gas supply configured to supply gas to the high pressure region, and a vacuum pump configured to remove gas from the low pressure region.

According to a preferred embodiment, the radiation source is a laser produced plasma source comprising a radiation source that is configured to focus a beam of coherent radiation, of a predetermined wavelength, onto a fuel, wherein the spectral purity filter is configured to filter at least part of radiation having the predetermined wavelength of the coherent radiation from the radiation generated by the source. For example, the predetermined wavelength may be about 10.6 micron.

According to an embodiment, the spectral purity filter can be configured to filter at least part of radiation having a first wavelength from radiation having a second wavelength, wherein the first wavelength is at least ten times larger than the second wavelength.

In a further embodiment, the system is configured to achieve a pressure greater than 10 Pa in the high pressure region.

Also, for example, the spectral purity filter can be configured to diffract at least part of the radiation over a predetermined diffraction angle, wherein the spectral purity filter and the radiation emission aperture are arranged to substantially prevent emission of the diffracted radiation part via the aperture.

According to a further embodiment, the spectral purity filter and the radiation emission aperture are spaced apart from each other by a distance greater than about 1 m.

In a preferred embodiment, the high pressure region has a pressure greater than about 100 Pa and the low pressure region has a pressure lower than about 20 Pa.

According to an embodiment there is provided a lithographic spectral purity filter including a plurality of apertures, the spectral purity filter being configured to enhance the spectral purity of a radiation beam by reflecting radiation of a first wavelength, the first wavelength being larger than about 10 microns, and by diffracting radiation of a second wavelength over a predetermined diffraction angle, the second wavelength being in the deep ultraviolet range, and the predetermined angle being about 1 mrad or larger.

According to an embodiment, there is also provided a method to provide a radiation beam, including providing a radiation source that generates a radiation; providing an aperture to emit the radiation beam; providing a radiation collector that collects the radiation generated by the source, and transmits the collected radiation to the aperture; and providing a spectral purity filter that enhances the spectral purity of the radiation,

wherein the filter upholds a pressure difference in the chamber, resulting in the chamber having a high pressure region and a low pressure region.

According to an embodiment there is provided a method to provide a radiation beam, including: providing a radiation source that generates a radiation; providing an aperture to emit the radiation beam; providing a radiation collector that collects the radiation generated by the source, and transmits the collected radiation to the aperture; and
providing a spectral purity filter that enhances the spectral purity of the radiation, wherein the filter diffracts at least part of undesired radiation, over a predetermined diffraction angle, to substantially prevent that radiation part to reach the radiation emission aperture.

### BRIEF DESCRIPTION OF THE DRAWINGS

Embodiments of the invention will now be described, by way of example only, with reference to the accompanying schematic drawings in which corresponding reference symbols indicate corresponding parts, and in which:

FIG. 1 depicts a lithographic apparatus in accordance with an embodiment of the invention;

FIG. 2 depicts a lithographic apparatus in accordance with an embodiment of the invention;

FIG. 3 depicts a radiation source and a normal incidence collector in accordance with an embodiment of the invention;

FIG. 4 depicts a radiation source and a Schwarzschild type normal incidence collector in accordance with an embodiment of the invention;

FIG. 5 depicts a cross-section of a radiation source, a normal incidence collector and a spectral purity filter in accordance with an embodiment of the invention;

FIG. 6a schematically depicts a diffracting mode of operation of a filter in case of normal incident radiation in accordance with an embodiment of the invention;

FIG. 6b is similar to FIG. 6a, and shows a diffracting mode of operation of the embodiment of FIG. 5;

FIG. 7 depicts a cross-section of a radiation source, a normal incidence collector, and a tilted spectral purity filter in accordance with an embodiment of the invention;

FIG. 8 depicts a cross-section of a radiation source, a normal incidence collector and a conical spectral purity filter in accordance with an embodiment of the invention;

FIG. 9 depicts a cross-section of a debris mitigation system in accordance with an embodiment of the invention;

FIG. 10 schematically depicts a filter, in perspective front view in accordance with an embodiment of the invention; and

FIG. 11 schematically depicts a filter, in perspective front view in accordance with an embodiment of the invention.

### DETAILED DESCRIPTION

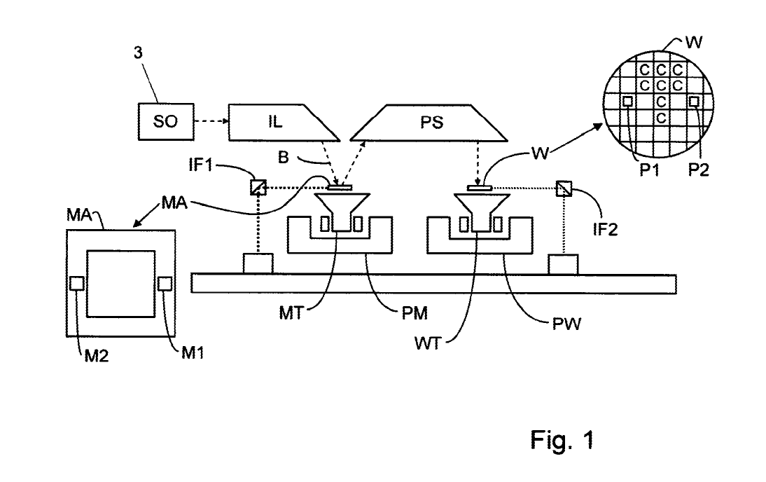

FIG. 1 schematically depicts an embodiment of a lithographic apparatus, that can be or include an embodiment of the invention. The apparatus includes an illumination system (illuminator) IL configured to condition a radiation beam B (e.g. EUV radiation); a support structure or patterning device support (e.g. a mask table) MT constructed to support a patterning device (e.g. a mask or a reticle) MA and connected to a first positioner PM configured to accurately position the patterning device; a substrate table (e.g. a wafer table) WT constructed to hold a substrate (e.g. a resist-coated wafer) W and connected to a second positioner PW configured to accurately position the substrate; and a projection system (e.g. a reflective projection lens system) PS configured to project a pattern imparted to the radiation beam B by patterning device MA onto a target portion C (e.g. including one or more dies) of the substrate W.

The illumination system may include various types of optical components, such as refractive, reflective, magnetic, electromagnetic, electrostatic or other types of optical components, or any combination thereof, for directing, shaping, or controlling radiation.

The support structure MT holds the patterning device MA in a manner that depends on the orientation of the patterning device, the design of the lithographic apparatus, and other conditions, such as for example whether or not the patterning device is held in a vacuum environment. The support structure can use mechanical, vacuum, electrostatic or other clamping techniques to hold the patterning device. The support structure may be a frame or a table, for example, which may be fixed or movable as required. The support structure may ensure that the patterning device is at a desired position, for example with respect to the projection system.

The term “patterning device” should be broadly interpreted as referring to any device that can be used to impart a radiation beam with a pattern in its cross-section such as to create a pattern in a target portion of the substrate. The pattern imparted to the radiation beam may correspond to a particular functional layer in a device being created in the target portion, such as an integrated circuit.

The patterning device may be transmissive or reflective. Examples of patterning devices include masks, programmable mirror arrays, and programmable LCD panels. Masks are well known in lithography, and include mask types such as binary, alternating phase-shift, and attenuated phase-shift, as well as various hybrid mask types. An example of a programmable mirror array employs a matrix arrangement of small mirrors, each of which can be individually tilted so as to reflect an incoming radiation beam in different directions. The tilted mirrors impart a pattern in a radiation beam which is reflected by the mirror matrix.

The term “projection system” may encompass any type of projection system, including refractive, reflective, catadioptric, magnetic, electromagnetic and electrostatic optical systems, or any combination thereof, as appropriate for the exposure radiation being used, or for other factors such as the use of an immersion liquid or the use of a vacuum. It may be desired to use a vacuum for EUV or electron beam radiation since other gases may absorb too much radiation or electrons. A vacuum environment may therefore be provided to the whole beam path with the aid of a vacuum wall and vacuum pumps.

As here depicted, the apparatus is of a reflective type (e.g. employing a reflective mask). Alternatively, the apparatus may be of a transmissive type (e.g. employing a transmissive mask).

The lithographic apparatus may be of a type having two (dual stage) or more substrate tables (and/or two or more mask tables). In such “multiple stage” machines the additional tables may be used in parallel, or preparatory steps may be carried out on one or more tables while one or more other tables are being used for exposure.

Referring to FIG. 1, the illuminator IL receives a radiation beam from a radiation source SO. The source SO may be part of a radiation system 3 (i.e. radiation generating unit 3). The radiation system 3 and the lithographic apparatus may be separate entities. In such cases, the radiation system 3 is not considered to form part of the lithographic apparatus and the radiation beam is passed from the source SO of radiation system 3 to the illuminator IL with the aid of a beam delivery system including, for example, suitable directing mirrors and/or a beam expander. In other cases, the source may be an integral part of the lithographic apparatus

The source SO of the radiation system 3 may be configured in various ways. For example, the source SO may be a discharge-produced plasma source (DPP source). Besides, the source SO may be a laser produced plasma source (LPP source), for example a Tin LPP source (such LPP sources are known per se). The source SO may also be a different type of radiation source.

The illuminator IL may include an adjuster for adjusting the angular intensity distribution of the radiation beam. Generally, at least the outer and/or inner radial extent (commonly referred to as σ-outer and σ-inner, respectively) of the intensity distribution in a pupil plane of the illuminator can be adjusted. In addition, the illuminator IL may include various other components, such as an integrator and a condenser. The illuminator may be used to condition the radiation beam, to have a desired uniformity and intensity distribution in its cross-section.

The radiation beam B is incident on the patterning device (e.g., mask) MA, which is held on the support structure (e.g., mask table) MT, and is patterned by the patterning device. After being reflected from the patterning device (e.g. mask) MA, the radiation beam B passes through the projection system PS, which focuses the beam onto a target portion C of the substrate W. With the aid of the second positioner PW and position sensor IF2 (e.g. an interferometric device, linear encoder or capacitive sensor), the substrate table WT can be moved accurately, e.g. so as to position different target portions C in the path of the radiation beam B. Similarly, the first positioner PM and another position sensor IF1 can be used to accurately position the patterning device (e.g. mask) MA with respect to the path of the radiation beam B. Patterning device (e.g. mask) MA and substrate W may be aligned using mask alignment marks M1, M2 and substrate alignment marks P1, P2.

The depicted apparatus could be used in at least one of the following modes:

1. In step mode, the support structure (e.g. mask table) MT and the substrate table WT are kept essentially stationary, while an entire pattern imparted to the radiation beam is projected onto a target portion C at one time (i.e. a single static exposure). The substrate table WT is then shifted in the X and/or Y direction so that a different target portion C can be exposed.

2. In scan mode, the support structure (e.g. mask table) MT and the substrate table WT are scanned synchronously while a pattern imparted to the radiation beam is projected onto a target portion C (i.e. a single dynamic exposure). The velocity and direction of the substrate table WT relative to the support structure (e.g. mask table) MT may be determined by the (de-)magnification and image reversal characteristics of the projection system PS.

3. In another mode, the support structure (e.g. mask table) MT is kept essentially stationary holding a programmable patterning device, and the substrate table WT is moved or scanned while a pattern imparted to the radiation beam is projected onto a target portion C. In this mode, generally a pulsed radiation source is employed and the programmable patterning device is updated as required after each movement of the substrate table WT or in between successive radiation pulses during a scan. This mode of operation can be readily applied to maskless lithography that utilizes programmable patterning device, such as a programmable mirror array of a type as referred to above.

Combinations and/or variations on the above described modes of use or entirely different modes of use may also be employed.

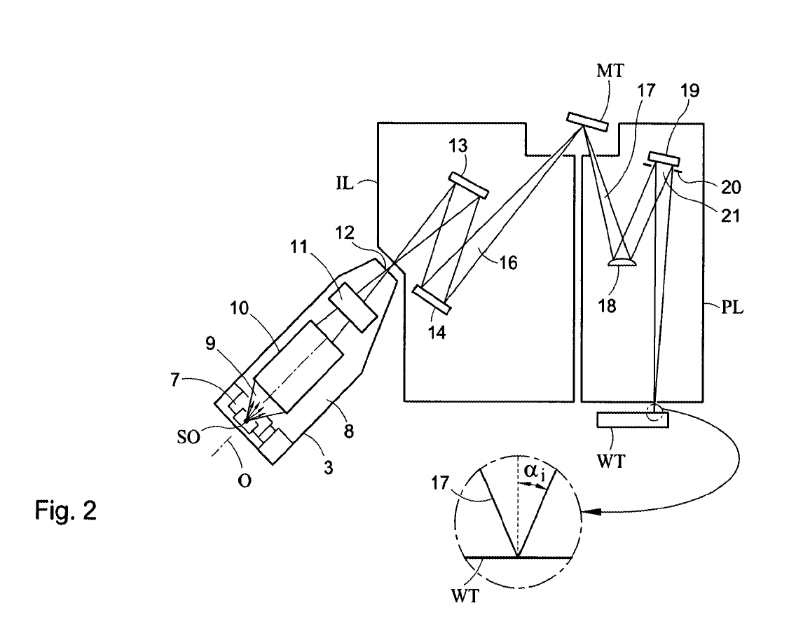

FIG. 2 schematically shows a further embodiment of an EUV lithographic apparatus, having a principle of operation that is similar to the operation of the apparatus shown in the embodiment of FIG. 1. A lithographic apparatus is shown in FIG. 2 of US2006/0146413A1.

In the embodiment of FIG. 2, the apparatus includes a source-collector-module or radiation unit 3 (also referred to herein as a radiation system), an illumination system IL and a projection system PL. According to an embodiment, radiation unit 3 is provided with a radiation source SO, preferably a LPP source. In the present embodiment, the radiation emitted by radiation source SO may be passed from the source chamber 7 into a chamber 8 via a gas barrier or “foil trap” 9. In FIG. 2, the chamber 8 includes a radiation collector 10. Radiation passed by collector 10 transmits through a spectral purity filter 11.

FIG. 2 depicts the application of a grazing incidence collector 10.

However, preferably, the collector may be a normal incidence collector (see below), particularly in the case the source is a LPP source. In yet another embodiment, the collector is a Schwarzschild collector (see FIG. 4), and the source is a DPP source.

The radiation may be focused in a virtual source point 12 (i.e. an intermediate focus IF) from an aperture in the chamber 8. From chamber 8, the radiation beam 16 is reflected in illumination system IL via normal incidence reflectors 13,14 onto a patterning device (e.g. reticle or mask) positioned on support structure or patterning device support (e.g. reticle or mask table) MT. A patterned beam 17 is formed which is imaged by projection system PL via reflective elements 18,19 onto wafer stage or substrate table WT. More elements than shown may generally be present in the illumination system IL and projection system PL.

One of the reflective elements 19 may have in front of it a numerical aperture (NA) disc 20 having an aperture 21 therethrough. The size of the aperture 21 determines the angle α, subtended by the patterned radiation beam 17 as it strikes the substrate table WT.

FIG. 2 shows an embodiment wherein a spectral purity filter 11 is positioned downstream of the collector 10 and upstream of the virtual source point 12. In an alternative embodiment, not shown, the spectral purity filters 11 may be positioned at the virtual source point 12 or at any point between the collector 10 and the virtual source point 12.

In other embodiments, the radiation collector is one or more of a collector configured to focus collected radiation into the radiation beam emission aperture; a collector having a first focal point that coincides with the source and a second focal point that coincides with the radiation beam emission aperture; a normal incidence collector; a collector having a single substantially ellipsoid radiation collecting surface section; and a Schwarzschild collector having two radiation collecting surfaces.

Also, in another embodiment (see below), the radiation source SO may be a laser produced plasma (LPP) source including a light source that is configured to focus a beam of coherent light, of a predetermined wavelength, onto a fuel.

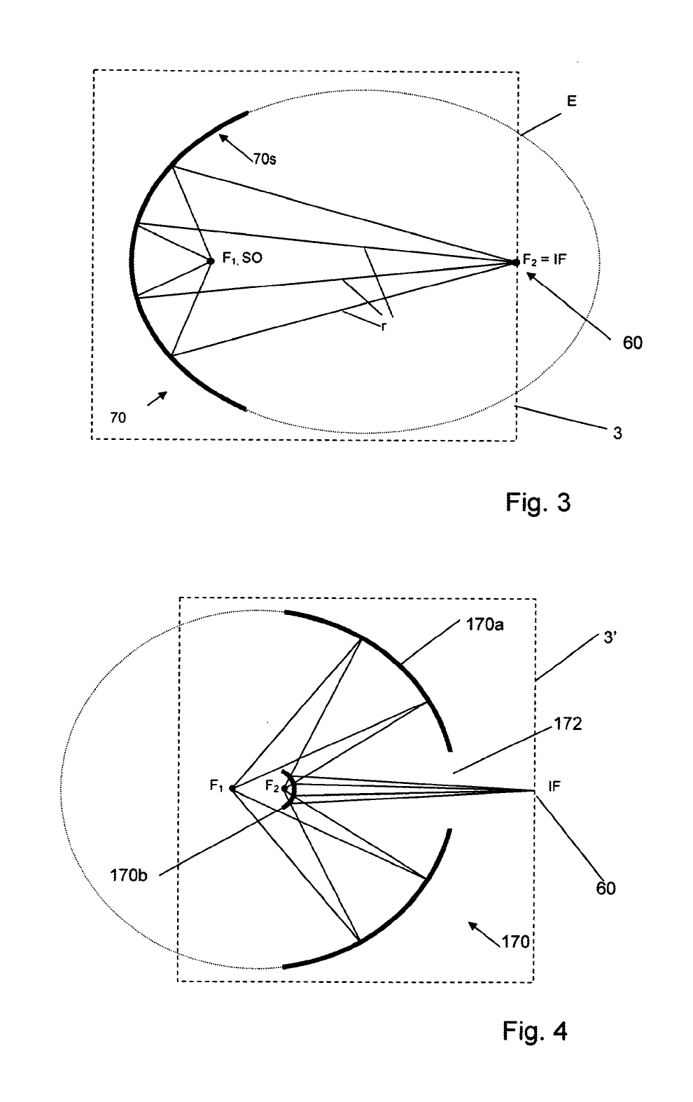

For example, FIG. 3 shows an embodiment of a radiation source unit 3, in cross-section, including a normal incidence collector 70. The collector 70 has an elliptical configuration, having two natural ellipse focus points F1, F2. Particularly, the normal incidence collector includes a collector having a single radiation collecting surface 70s having the geometry of the section of an ellipsoid. In other words: the ellipsoid radiation collecting surface section extends along a virtual ellipsoid (part of which is depicted by as dotted line E in the drawing).

As will be appreciated by the skilled person, in case the collector mirror 70 is ellipsoidal (i.e., including a reflection surface 70s that extends along an ellipsoid), it focuses radiation from one focal point F1 into another focal point F2. The focal points are located on the long axis of the ellipsoid at a distance f=(a2-b2)½ from the center of the ellipse, where 2a and 2b are the lengths of the major and minor axes, respectively. In case that the embodiment shown in FIG. 1 includes an LPP radiation source SO, the collector 1 is preferably a single ellipsoidal mirror as shown in FIG. 2, where the light source SO is positioned in one focal point (F1) and an intermediate focus IF is established in the other focal point (F2) of the mirror. Radiation emanating from the radiation source, located in the first focal point (F1) towards the reflecting surface 70s and the reflected radiation, reflected by that surface towards the second focus point F2, is depicted by lines r in the drawing. For example, according to an embodiment, a mentioned intermediate focus IF may be located between the collector and an illumination system IL (see FIGS. 1, 2) of a lithographic apparatus, or be located in the illumination system IL, if desired.

FIG. 4 schematically shows a radiation source unit 3′ in accordance with an embodiment of the invention, in cross-section, including a collector 170. In this case, the collector includes two normal incidence collector parts 170a, 170b, each part 170a, 170b preferably (but not necessarily) having a substantially ellipsoid radiation collecting surface section. Particularly, the embodiment of FIG. 4 includes a Schwarzschild collector design, preferably consisting of two mirrors 170a, 170b. The source SO may be located in a first focal point F1. For example, the first collector mirror part 170a may have a concave reflecting surface (for example of ellipsoid or parabolic shape) that is configured to focus radiation emanating from the first focal point F1 towards the second collector mirror part 170b, particularly towards a second focus point F2. The second mirror part 170b may be configured to focus the radiation that is directed by the first mirror part 170a towards the second focus point F2, towards a further focus point IF (for example an intermediate focus). The first mirror part 170a includes an aperture 172 via which the radiation (reflected by the second mirror 170b) may be transmitted towards the further focus point IF. For example, the embodiment of FIG. 3 may beneficially be used in combination with a DPP radiation source.

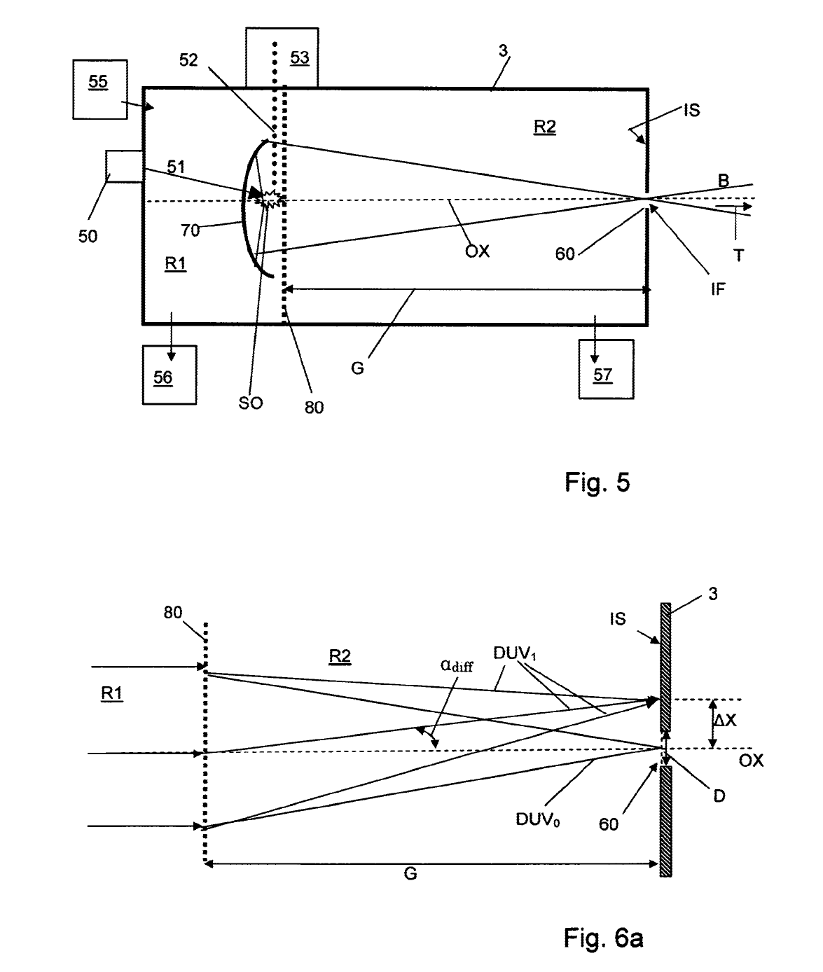

FIG. 5 shows a cross-section of an embodiment of a radiation system 3 configured to generate a radiation beam B. In a further embodiment, the radiation system 3 is part of a lithographic apparatus, for example the apparatus shown in any of FIG. 1 or 2. The radiation system can be used, for example, in a device manufacturing method that includes projecting a patterned beam of radiation onto a substrate.

As follows from FIG. 5, the radiation system can include a chamber (for example a casing or housing) 3 that includes the radiation source SO (that is configured to generate radiation). The chamber 3 is provided with a radiation emission aperture 60, to emit radiation from/out of the chamber, and a normal incidence radiation collector 70. Preferably, but not necessarily, the collector 70 may be of a type shown in FIG. 3 or 4.

In a further embodiment, the chamber 3 includes a sealed chamber, preferably configured to hermetically seal the content of the chamber from an environment thereof (as in FIG. 5). In the present embodiment, the chamber (or source unit) 3 has a radiation emission aperture (opening) 60 that is provided in a respective wall of the source unit 3, through which aperture a radiation beam B may be emitted in a certain direction T (for example along an optical axis OX).

In the present embodiment, the source SO is a LPP source, that is associated with a laser source 50 configured to generate a laser beam 51 of coherent light, having a predetermined wavelength. The laser light 51 is focused onto a fuel 52 (the fuel for example being supplied by a fuel supplier 53, and for example including fuel droplets) to generate radiation there-from, in a laser produced plasma process. The resulting radiation may be EUV radiation, in this embodiment. In a non-limiting embodiment, the predetermined wavelength of the laser light is 10.6 microns (i.e. μm). For example, the fuel may be tin (Sn), or a different type of fuel, as will be appreciated by the skilled person.

The radiation collector 70 may be configured to collect radiation generated by the source, and to focus collected radiation to the downstream radiation beam emission aperture 60 of the chamber 3.

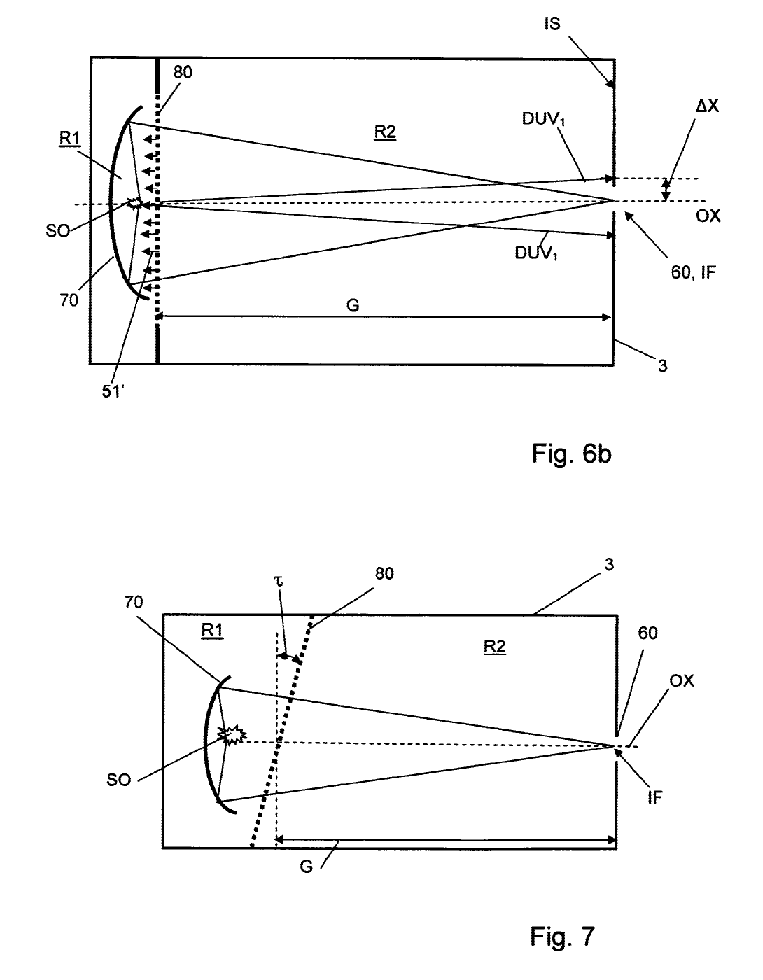

For example, the source SO may be configured to emit diverging radiation, and the collector 70 may be arranged to reflect that diverging radiation to provide a converging radiation beam, converging towards the emission aperture 60 (as in FIGS. 5-6). Particularly, the collector 70 may focus the radiation onto a focal point IF on an optical axis OX of the system (see FIG. 6), which focal point IF is located in the emission aperture 60.

The emission aperture 60 may be a circular aperture, or have another shape (for example elliptical, square, or another shape). The emission aperture 60 is preferably small, for example having a diameter D less than about 10 cm, preferably less than 1 cm, (measured in a direction transversally with a radiation transmission direction T, for example in a radial direction in case the aperture 60 has a circular cross-section). Preferably, the optical axis OX extends centrally through the aperture 60, however, this is not essential.

Preferably, the chamber 3 includes a spectral purity filter 80 configured to enhance a spectral purity of the radiation that is to be emitted via the aperture 60. In a further embodiment, the filter 80 is configured to transmit only a desired spectral part of radiation towards the aperture 60. For example the filter 80 may be configured to reflect, block, or redirect other ‘undesired’ spectral parts of the radiation. Preferably, the filter 80 is configured to provide a combination of one or more of blocking, redirecting and reflecting other ‘undesired’ spectral parts of the radiation. In a preferred embodiment, the filter 80 is also configured to act as a pressure barrier (see below) between two regions (for example interior spaces) R1, R2 of the system.

According to a preferred embodiment, the filter 80 may be configured to prevent emission of certain spectral radiation parts via the emission aperture 60, utilizing diffraction of that spectral part (see below, and FIG. 6).

In a further embodiment, a desired spectral part (i.e. to be emitted via the aperture 60) is EUV radiation (for example having a wavelength lower than 20 nm, for example a wavelength of 13.5 nm). Preferably, the filter 80 is configured to transmit at least 50%, preferably more than 80%, of incoming radiation (i.e. radiation that is directed towards the filter from the source SO and/or collector 70) of that desired spectral part.

The filter 80 may be configured to prevent various ‘undesired’ spectral parts of incoming radiation (particularly radiation emitted by the collector 70 towards the filter 80) to reach the radiation emission aperture 60. For example, such ‘undesired’ spectral parts may be spectral parts in a DUV (deep ultraviolet) range (for example a range of about 190-250 nm), infrared light, and/or the predetermined wavelength of the above-mentioned laser source light 51.

In a more preferred embodiment, the filter 80 is configured to transmit EUV radiation to focal point IF in the aperture 60, and to at least partly prevent transmission of both DUV and the predetermined laser light wavelength via the aperture 60. To that aim, preferably, the filter 80 may be arranged to reflect incoming radiation of the predetermined laser light wavelength, and to diffract DUV light (away from the aperture 60).

For example, the filter 80 may be configured to filter at least part radiation having a first wavelength from radiation having a second wavelength, wherein the first wavelength is at least ten times larger than the second wavelength.

According to a preferred embodiment, the spectral purity filter 80 may be configured to filter at least part of radiation having the predetermined wavelength of the coherent laser light 51, from radiation that is to be emitted. Particularly, a desired part of radiation that is to be emitted has a significantly lower wavelength than the coherent laser light. The wavelength of the coherent laser light 51 may be, for example, larger than 10 microns. In a more specific embodiment, the coherent laser light, to be filtered out, has a wavelength of 10.6 microns.

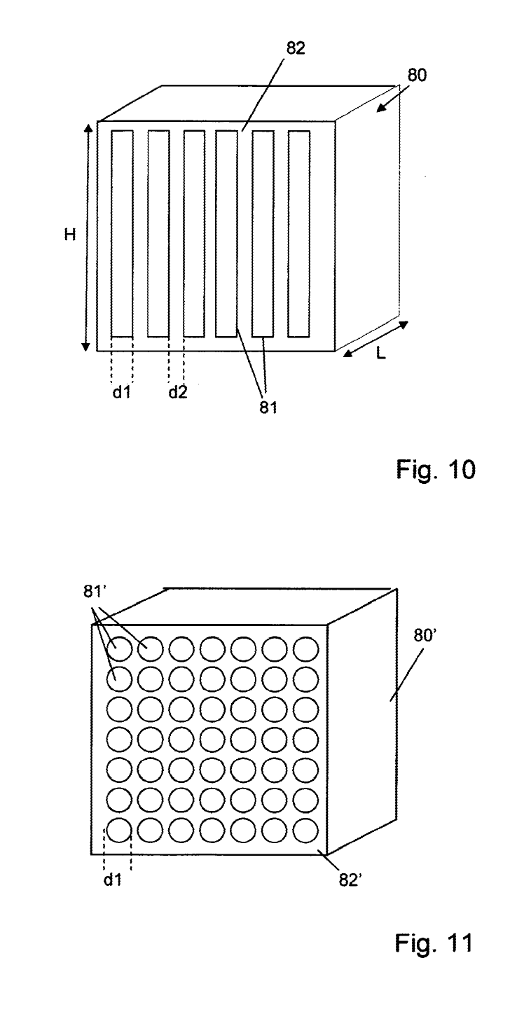

Also, in the present embodiment, the spectral purity filter 80 may be configured to (physically) divide the chamber 3 into a high pressure region R1 and a low pressure region R2. As follows from FIG. 5, to this aim, the filter 80 may be a physical barrier extending between the two regions R1, R2, which barrier preferably includes a large number of small radiation transmission channels or apertures to transmit radiation to the emission aperture 60 of the low pressure region R2. The radiation transmission channels of the filter 80 may be dimensioned to restrict gas flow from the high pressure region R1 to the lower pressure region R2. For example, radiation transmission channel dimensions of the filter, configured to uphold a predetermined pressure difference between the regions R1, R2 at a predetermined pressure in the first region R1, may be determined empirically and/or using calculations, as will be appreciated by the skilled person. Examples of some channel dimensions are mentioned below, in respect of FIGS. 10-11.

The collector 70 may be included in, or can abut, the high pressure region R1, as in the present embodiment. Also, the low pressure region R2 may be arranged between the spectral purity filter 80 and the radiation emission aperture 60. For example (see FIG. 5), one side (a front side) of the filter 80 may be faced towards the source SO and/or collector to receive radiation there-from, and the other (back) side of the filter may be faced towards the radiation emission aperture 60 of the system 3. Preferably, the filter 80 is arranged near the source area (for example an area that is the LPP source SO, particularly an area that contains a radiation emitting fuel or fuel droplet during operation) for example at a distance smaller than about 1 m, and preferably at a distance less than about 25 cm.

Besides, in an embodiment, the filter 80 and the radiation emission aperture 60 may be spaced-apart from each other by a relatively large distance G, for example a distance of about 1 m or more, and preferably a distance of about 1.5 m or more, or about 2 m or more. In an example, the distance G may be in the range of about 1.5-2.5 m.

The system may be provided with a gas supply 55 configured to feed gas, preferably inert gas, preferably an EUV transparent gas, for example Helium (H2), argon (Ar), hydrogen (H₂), or a different gas, to the high pressure region R1. Besides, a gas outlet 56 may be provided to remove gas from the high pressure region R1, for example to continuously refresh the gas during operation.

Also, a vacuum pump 57 may be provided, configured to remove gas from the low pressure region R2. The skilled person will appreciate that the mentioned gas supply 55, outlet 56 and pump 57 may be configured in various ways, and may include one or more gas sources, gas sinks, valve means, gas supply and exhaust lines, flow controllers, and other means to regulate or set desired pressures in the regions R1, R2.

The radiation system may be configured to achieve a pressure higher than about 10 Pa, particularly higher than about 100 Pa, in the high pressure region R1, and a pressure lower than the high pressure Pa in the low pressure region. For example, the pressure in the low pressure region may be at most 20% of the pressure in the high pressure region. For example, in case the pressure in the high pressure region is about 100 Pa or larger, the pressure in the low pressure region may be about 20 Pa or lower. According to a further embodiment, the pressure in the low pressure region R2 is lower than about 10 Pa (for example about 2 Pa), during operation. Besides, for example, during operation of the system 3, the pressure difference between the high pressure region R1 and low pressure region R2 can be larger than 10 Pa. The pressure difference may be larger than about 50 Pa, or about 100 Pa.

According to an embodiment, the spectral purity filter is a diffraction filter 80, that may be configured to diffract at least an ‘undesired’ part of incoming radiation over a predetermined diffraction angle α_{diff}. Then, the filter 80 and the radiation emission aperture 60 may be arranged (i.e. mutually oriented in a predetermined manner) to substantially prevent emission of the diffracted radiation part via that aperture 60 (see FIG. 6).

For example, the spectral purity filter 80 may prevent that more than about 50% (i.e. >50%) of an ‘undesired’ spectral part of incoming radiation, and preferably more than about 90% and more preferably more than about 95% of that spectral part, to be emitted via the aperture 60.

In a further embodiment, at least first order diffraction parts of diffracted radiation spectrum parts are projected outside the radiation emission aperture 60 of the chamber 3 by the diffraction filter 80. In a preferred embodiment (see FIGS. 7-9), the filter 80 may have a plane of incidence that is not normal with respect to an optical transmission axis OX of the radiation beam B to be emitted. In this case, a relatively large plane of incidence can be available.

In an embodiment, the filter (or pressure barrier) 80 is located centrally on the optical axis OX of the illumination system 3 (that is, the optical axis OX extends through the centre of the filter 80). Also, a centre of a diffraction pattern of the filter 80 may coincide with a centre of a radiation beam that is focused by the collector 70 onto the intermediate focus point IF.

For example, the filter 80 may diffract radiation, such that at least part of a resulting diffracted radiation part is projected onto an inner surface IS of a chamber wall that includes the aperture 60. Also, preferably, for example, the inner surface IS of that chamber wall, which surface received diffracted radiation from the filter 80, may be configured to substantially absorb that diffracted radiation part.

The diffraction filter 80, preferably also acting as a pressure barrier (i.e. chamber divider) during operation, may be configured in various ways. FIGS. 10 and 11 show non-limiting examples 80, 80′ of such a filter, that may act both as a radiation spectral filter as well as a pressure barrier.

The filters 80, 80′ may be a relatively rigid structure or filter element, preferably being relatively thin measured in a direction parallel to the optical axis OX, for example a rigid sheet, panel, plate or foil, configured to uphold an above-mentioned pressure difference between the regions R1, R2 during operation of the system 3. The filters 80, 80′ are preferably dimensioned to at least receive all radiation, collected by the collector 70 from the source SO and transmitted by the collector 70 to the emission aperture 60.

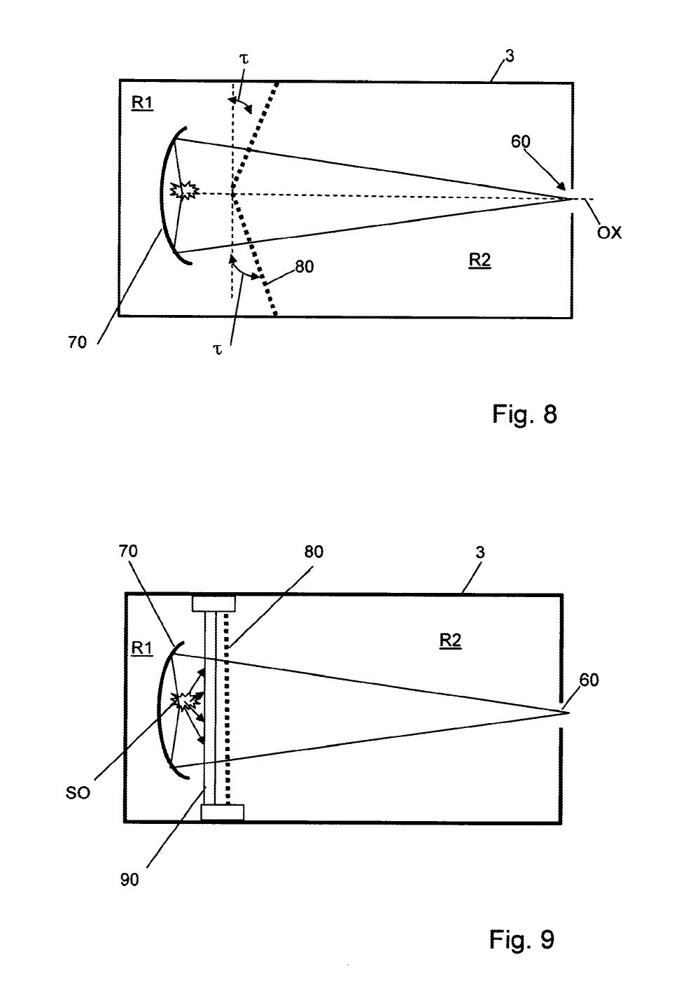

In FIGS. 5, 6a, 6b, the filter 80 is shown as being substantially normal with respect to the optical axis OX. In a further embodiment, the filter 80 may have different shape and/or orientation, for example tilted (see FIG. 7), conical (see FIG. 8), hemispherical, or other shapes and orientations.

According to a non-limiting embodiment, a thickness L of the filters 80, 80′ (see FIG. 10, 11) is smaller than about 1 mm, and preferably smaller than about 0.1 mm. For example, this thickness L may be smaller than 50 microns. In a more preferred embodiment the thickness of the filter is in the range of about 10-20 μm, for example about 10 μm.

For example, the filter 80, 80′ may be made of, or consist of, a metal, an alloy, aluminium, steel, or a different material. The filter may also be made in a different manner. The filter 80, 80′ may also be provided with one or more layers, or include a sandwich structure. For example, at least one surface of the filter 80, 80′ may be provided with one or more radiation reflective layers or coatings 82, 82′ to substantially reflect part of incoming radiation 51 of the laser 50 back towards the first region R1 (see below).

According to an embodiment, also, the spectral purity filter 80, 80′ may be combined with a very thin layer of for instance Zr, for example a continuous layer, without holes, extending over/provided on top of the filter part that does have transmission apertures 81, 81′, to block near EUV and DUV contributions.

For example, the filter 80, 80′ may be a lithographic spectral purity filter including a plurality of apertures 81, 81′, the spectral purity filter being configured to enhance the spectral purity of a radiation beam by reflecting radiation 51 of a first wavelength (for example, the first wavelength may be larger than about 10 microns), and by diffracting radiation of a second wavelength over a predetermined diffraction angle α_{diff} (the second wavelength for example being in the deep ultraviolet range). In a further embodiment, the predetermined angle is 1 mrad or larger, for example 5 mrad or larger.

For example, the apertures 81, 81′ of the filter may be manufactured using laser induced abrasive techniques, for example laser cutting or laser induced perforation, or in a different manner.

The lithographic spectral purity filter 80, 80′ may include a plurality of apertures 81, 81′, the spectral purity filter being configured to enhance the spectral purity of a lithographic radiation beam, wherein the plurality of apertures are arranged in a regular (2-dimensional) pattern (in front view and when viewed in a cross-section), having a diffraction period d larger than 10 microns, to act as a diffraction grating for radiation of a predetermined wavelength. Besides, the apertures 80, 80′ are relatively small so that an effective gas pressure barrier functionality is achieved by the filter during operation.

The filter embodiment of FIG. 10 is a diffraction grating, having a plurality of elongate, parallel slits 81, having a diameter d1 with a spacing d2 between the slits. In this embodiment, the slits 81 have a depth that is equal to the thickness L of the filter. Preferably, a height H of each slit 81 can be larger than a cross-section of incoming radiation (emitted from the collector 70) to be filtered, for example larger than 1 cm, particularly larger than 10 cm.

Preferably, the filter 80 includes a periodic array (i.e. having constant values for d1 and d2) of slits 81. For example, the slits 81 may extend substantially normally with respect to a front side 82 of the filter 80. In the present embodiment, the diameter (or width) d1 of each slit 81 is preferably larger than 10 microns. Also, for example, the spacing d2 between the slits may be larger than 1 microns, for example about 10 microns or larger. According to an embodiment, the aforementioned diffraction period d (wherein d=d1+d2) is about 20 microns or larger. For example, the diffraction period may be in the range of about 10-40 microns, more particularly the range of about 15-25 microns. In this way, diffraction of DUV light may be achieved by the filter, sufficient to project at least a part of such light (for example at least 20% of incoming DUV light) outside the emission aperture 60.

FIG. 11 shows an alternative diffractive spectral purity filter embodiment 80′, which differs from the embodiment of FIG. 10 in that the filter 80′ including a large number of parallel pinholes 81′, preferably having the same diameter d1′, and preferably extending substantially normally with respect to a front face 82′ of the filter element 80′. In this embodiment, the holes have circular cross-sections, however, holes having different cross-sections (for example squares) may also be provided. Preferably, the pinholes 81′ are arranged in a geometric regular pattern, to provide diffraction of (preferably a DUV) part of incoming radiation. A spacing between nearest pinholes may be about the diameter of the pinholes, of have a different value. A diameter of each of the pinholes may be larger than about 10 microns. Alternatively, a pinhole diameter may be about 10 microns, or smaller.

Also, for example, the pattern of pinholes 81′ may provide a respective radiation diffraction period of about 20 microns or larger. For example, the diffraction period may be in the range of about 10-40 microns, more particularly in the range of about 15-25 microns. Operation of the embodiment of FIG. 11 is substantially the same as operation of the FIG. 10 filter embodiment.

During operation of the system of FIG. 5, there may be provided a method to provide a radiation beam. The method may include providing the radiation source SO that generates radiation. The collector 70 collects radiation, generated by the source SO, and transmits (focuses) the collected radiation via the filter 80 to the aperture 60.

During operation, the filter 80 enhances the spectral purity of the radiation. Also, the filter 80 upholds a pressure difference in the chamber, resulting the pressure in the source/collector R1 being higher than the pressure in the downstream low pressure region R2.

Preferably, in the case that the source SO is a laser produced plasma (LPP) source including a light source that is configured to focus a beam of coherent light, of a predetermined wavelength, onto a fuel, the spectral purity filter filters at least part of the coherent laser light from radiation during operation.

The relatively high pressure in the collector/source zone R1 may provide protection to the collector 70. For example, a relatively high pressure of gas in the respective space R2, in a range of about 40-100 Pa, may considerably increase collector lifetime.

Besides, during operation, the reflective surface 82 of the filter 80 may substantially prevent transmission of incoming laser light 51 (of the LPP source) towards the emission aperture 60 of the system 3. Particularly, the filter 80 reflects that type of radiation back into the high pressure region R1 (this reflection is schematically indicated by arrows 51′ in FIG. 6).

Also, operation of the system of FIG. 5 preferably includes the filter 80 diffracting at least part DUV₁ of undesired DUV radiation (having a predetermined wavelength), over at least one predetermined diffraction angle, for example to substantially prevent that radiation part DUV₁ to reach the radiation emission aperture 60. This is indicated in more detail in the embodiments of FIGS. 6a, 6b.

An example of diffraction of normal incident DUV radiation by the filter 80 (i.e. an angle of incidence is 90 degrees with respect to a front surface 82 of the filter 80) is shown in FIG. 6a. In this case, a diffraction angle α_{diff} (rad) of the diffraction grating filter 80 is provided by the equation α_{diff}=nλ/d, wherein n is the diffraction order, λ the wavelength of the radiation to be diffracted (m), and d the above-mentioned diffraction period (m). As is indicated in FIG. 6a, in that case, the inner surface IS may receive a 1^{st} order diffracted radiation part DUV₁ (n=1) of DUV radiation, diffracted by the filter 80, at a point that is spaced-apart from the optical axis OX (in this case the centre of the radiation emission aperture 60) over a distance ΔX. In the embodiment of FIG. 6a, for a large distance G, this distance ΔX follows approximately from ΔX=α_{diff}.G. In the present embodiment, this distance ΔX is such that the respective first order diffracted radiation DUV₁ is not projected into the aperture 60. For example, in the present embodiment, this distance ΔX may be larger than about half the diameter D of the aperture 60. Also, preferably, the filter 60 generates a second order diffracted radiation part (n=2) of DUV radiation, emitted from the collector 70 towards the filter 80, such that the second order diffracted radiation does not reach the emission aperture 60. However, in the embodiment of FIG. 6a, a zeroth order (n=0) diffraction part of the incoming DUV radiation may still reach the centre of the emission aperture 60.

FIG. 6b shows an example, wherein the flat filter 80 diffracts incoming DUV radiation may have a small range of angles of incidence that are not normal with respect to the front filter surface 82. For example, this incoming radiation may be emanating from an upstream elliptical normal incidence collector 70. In that case, when the range of angles of incidence is relatively small, the grating may still provide diffraction of the DUV radiation such that first order diffracted parts are projected outside the emission aperture. Due to the range of angles of incidence, a small blurring of the diffraction can occur (i.e., the respective diffraction pattern will be less sharp as a pattern provided with the arrangement shown in FIG. 6a).

According to an embodiment of the invention, the filter 80 may be tilted over a tilting angle τ. Examples are shown in FIGS. 7 and 8. In this case, a relatively large plane of incidence may be available, and consequently, thermal loading of the filter may be reduced. For example, in the case a filter has one or more front surface parts (faced towards the source SO) that do not extend normally (i.e. transversally) with respect to the optical axis OX (for example one or more tilted or curved surface parts), the filter may provide a relatively large area to receive heat loads, so that the operating temperature of the filter can be controlled, or at least kept well within desired temperature operating ranges.

FIG. 7 shows an embodiment, that differs from the embodiment according to FIG. 6b in that the diffraction filter 80 is tilted over the tilting angle τ.

FIG. 8 shows an embodiment that differs from the embodiment of FIG. 7, in that the filter 80 has a conical shape, providing a tilted diffraction surface.

FIG. 9 shows a further example of the invention. In this embodiment, the radiation system also includes a shield 90 arranged to optically block all lines of sight between the source SO and the filter 80. For example, the shield 90 may be an integral part of the filter 80, or be separate therefrom. The shield 90 may have several shapes, for example cup shaped, conical, hemispherical, tilted, curved, straight, as will be appreciated by the skilled person. The shield 90 may be configured to allow EUV radiation transmission from the collector 70 to the radiation emission aperture 60 (via the filter 80) and may prevent transmission of EUV radiation in other directions. In this way, operating temperature of the filter 80′ may be controlled (at least, to prevent overhearing of the filter).

Besides, the radiation system 3 may include one or more contaminant traps, for example to trap source debris. The contaminant trap 9 may be configured in various ways, and may be located in various positions. According to a further embodiment, a pressure barrier (i.e. filter) 80 is supported by, or fixed to, the contaminant trap 9.

Thus, there may be provided a combined spectral purity filter and gas pressure barrier 80, for example to be used in combination with a LPP sources. This may result in transmission neutral spectral purity, may also provide improved suppression of contaminants Particularly, during operation of a LPP source, a relatively high pressure (typically about 40-100 Pa for about 200 mm distance between mirror) may be used to enhance collector lifetime, in the first region R1. However, this high pressure may absorb EUV light. Further, the EUV light of the LPP source may be contaminated by the (for example 10.6 microns) laser radiation or light 51 of the source or laser 50, and by DUV contributions. This light may cause heat problems in the illuminator, the reticle, the projection optics or the wafer, in case of application in a lithographic apparatus (see FIGS. 1-2). Embodiments of the present spectral purity filter 80 may remove unwanted wavelengths from the EUV beam, albeit with a transmission of about 70% for EUV.

Finally, the present embodiments are beneficial to prevent spreading of certain aggressive (highly reactive) substances or chemicals (for example halogen containing substances), that may optionally be used in the first region R1, for example, to clean the collector 70.

In an embodiment, a spectral purity filter 80 is placed in the EUV radiation beam in the source system 3. The filter 80 may also act as an efficient pressure barrier, particularly by being connected to the walls of the system 3 (for example being substantially sealed along to the radiation system walls).

In an embodiment, there is provided a spectral purity filter 80 that divides the source vessel 3 in two compartments, preferably to provide a large pressure drop over the filter 80, and for example such that transmission loss of the spectral purity filter can neutralized by a transmission gain of the lower pressure behind the filter (in the second region R2).

Also, as follows from the above, the filter 80, or parts thereof, may be placed under a predetermined angle with respect to an optical axis.

Preferably, the filter 80 is placed relatively far from the intermediate focus aperture 60, to work as a filter for DUV contributions. Also, for thermal reasons, preferably, the filter 80 may be placed relatively close to the collector 60. Alternatively, the filter 80 may be placed closer to the intermediate focus IF, so that an EUV transmission part of the filter may be reduced, which leads to further reduction of gas leakage over the filter.

As follows from the above, there may be provided a transmission neutral spectral purity filter also acting as a pressure barrier. The transmission loss may be compensated by the much lower pressure at the intermediate focus side. Above embodiments provide a reactive cleaning substance (for example halogen containing substances) reduction mechanism, by providing relatively low absolute partial pressures of such a substance. Due to relatively low pressures in the low pressure region R2, there improved contamination suppression schemes may be provided at the intermediate focus location IF.

The spectral purity filter 80 may be placed at a place with a relatively low heat load. The EUV beam is the widest in the source, so the heat load per unit area is lowest.

Moreover, in an embodiment, the filter 80 may tolerate a mentioned high pressure difference, which makes it possible to use a high pressure in the first region R1, and which is beneficial for collector lifetime, and a low pressure in the downstream are R2, which is beneficial for EUV transmission.

In the above, the spectral purity filter has been applied in radiation systems, including a radiation source. Alternatively, in a non-limiting example, the spectral purity filter may be applied in an illumination system IL of a lithographic apparatus.

### Example

In a non-limiting numerical example, a spectral purity filter 80′ according to the embodiment of FIG. 11 is used to diffract DUV radiation, in the configuration shown in FIGS. 5, 6b. The spectral purity filter 80′ also reflects a large fraction of incoming 10.6 microns radiation (e.g. laser radiation) 51 (at its front surface 82′). In this example, the transmission for EUV radiation is determined by the geometrical open fraction, which may be about 70% or higher. In this example, the spectral purity filter 80′ has 20 microns slits or holes (i.e. d1=20 μm). The first diffraction order of DUV radiation with a wavelength of about 200 nm may then be found at an angle of about 10 mrad. When this filter 80′ is placed at G=1.5 m from an intermediate focus aperture 60 of D=6 mm diameter, a considerable fraction of the DUV light will not pass through the intermediate focus aperture (in fact, in this case, only the zeroth order will pass).

For example, a large spectral purity filter 80′ having square, 20 μm² holes, located 25 μm apart, has 4.10⁸ holes for an area of 0.5*0.5 m². Note that in this particular example the filter has a geometrical transmission of 20²/25²=64%. Such a large number of holes with a pressure difference of, for example, about 100 Pa on the source side (in region 1) and 2 Pa on the intermediate focus side (i.e region R2), can leak about 8 Pam³/s gas at room temperature (T=273K). For example, using a 4000 l/s pump 57, this may lead to a pressure of about 2 Pa on the intermediate focus side (in region R2) of the spectral purity filter 80′. This low pressure may give a transmission gain of about 20% when a length of 1.5 m of the EUV light path is at a pressure of 2 Pa, instead of about 100 Pa gas.

Although specific reference may be made in this text to the use of lithographic apparatus in the manufacture of ICs, it should be understood that the lithographic apparatus described herein may have other applications, such as the manufacture of integrated optical systems, guidance and detection patterns for magnetic domain memories, flat-panel displays, liquid-crystal displays (LCDs), thin-film magnetic heads, etc.

Although specific reference may have been made above to the use of embodiments of the invention in the context of optical lithography, it will be appreciated that the invention may be used in other applications, for example imprint lithography, and where the context allows, is not limited to optical lithography.

The terms “radiation” and “beam” used herein encompass all types of electromagnetic radiation, including ultraviolet (UV) radiation (e.g. having a wavelength of or about 365, 355, 248, 193, 157 or 126 nm) and extreme ultra-violet (EUV) radiation (e.g. having a wavelength in the range of 5-20 nm), as well as particle beams, such as ion beams or electron beams.

While specific embodiments of the invention have been described above, it will be appreciated that the invention may be practiced otherwise than as described. For example, the invention may take the form of a computer program containing one or more sequences of machine-readable instructions describing a method as disclosed above, or a data storage medium (e.g. semiconductor memory, magnetic or optical disk) having such a computer program stored therein.

The descriptions above are intended to be illustrative, not limiting. Thus, it will be apparent to one skilled in the art that modifications may be made to the invention as described without departing from the scope of the claims set out below.

It is to be understood that in the present application, the term “including” does not exclude other elements or steps. Also, each of the terms “a” and “an” does not exclude a plurality. Any reference sign(s) in the claims shall not be construed as limiting the scope of the claims.

1. A radiation system configured to generate a radiation beam, the radiation system comprising a chamber including:
a radiation source configured to generate radiation; a radiation beam emission aperture;
a radiation collector configured to collect radiation generated by the source, and to transmit the collected radiation to the radiation beam emission aperture; and
a spectral purity filter configured to enhance a spectral purity of the radiation to be emitted via the aperture,
wherein the spectral purity filter is configured to divide the chamber into a high pressure region and a low pressure region.

2. The system according to claim 1, wherein the radiation source is configured to generate extreme ultraviolet radiation.

3. The system according to claim 1, wherein the collector is included in or abuts the high pressure region, wherein the low pressure region is arranged between the spectral purity filter and the radiation emission aperture.

4. The system according to claim 1, wherein the collector is one or more of:
a collector configured to focus collected radiation into the radiation beam emission aperture;
a collector having a first focal point that coincides with the radiation source and a second focal point that coincides with the radiation beam emission aperture;
a normal incidence collector;
a collector having a single substantially ellipsoid radiation collecting surface section; and
a Schwarzschild collector having two radiation collecting surfaces.

5. The system according to claim 1, comprising a gas supply configured to supply gas to the high pressure region, and a vacuum pump configured to remove gas from the low pressure region.

6. The system according to claim 1, wherein the radiation source is a laser produced plasma source comprising a radiation source that is configured to focus a beam of coherent radiation, of a predetermined wavelength, onto a fuel, wherein the spectral purity filter is configured to filter at least part of radiation having the predetermined wavelength of the coherent radiation from the radiation generated by the source.

7. The system according to claim 6, wherein the predetermined wavelength is about 10.6 micron.

8. The system according to claim 1, wherein the spectral purity filter is configured to filter at least part of radiation having a first wavelength from radiation having a second wavelength, wherein the first wavelength is at least ten times larger than the second wavelength.

9. The system according to claim 1, wherein the system is configured to achieve a pressure greater than 10 Pa in the high pressure region.

10. The system according claim 1, wherein the spectral purity filter is configured to diffract at least part of the radiation over a predetermined diffraction angle, wherein the spectral purity filter and the radiation emission aperture are arranged to substantially prevent emission of the diffracted radiation part via the aperture.

11. The system according to claim 1, wherein the spectral purity filter and the radiation emission aperture are spaced apart from each other by a distance greater than about 1 m.

12. The system according to claim 1, wherein the high pressure region has a pressure greater than about 100 Pa and the low pressure region has a pressure lower than about 20 Pa.

13. A lithographic spectral purity filter comprising a plurality of apertures, the spectral purity filter configured to enhance a spectral purity of a radiation beam by reflecting radiation of a first wavelength, the first wavelength being greater than about 10 microns, and by diffracting radiation of a second wavelength over a predetermined diffraction angle, the second wavelength being in the deep ultraviolet range, and the predetermined angle being greater than about 1 mrad.

14. A method of providing a radiation beam, comprising:
generating radiation with a radiation source;
emitting the radiation beam through an aperture;
collecting radiation generated by the source with a radiation collector, and transmitting the collected radiation to the aperture; and
enhancing the spectral purity of the radiation with a spectral purity filter,
wherein the spectral purity filter upholds a pressure difference in a chamber that includes the radiation source, the radiation collector and the spectral purity filter resulting in the chamber having a high pressure region and a low pressure region.

15. The method according to claim 14, wherein a pressure difference between the high pressure region and the low pressure region is greater than about 10 Pa, particularly greater than about 100 Pa.

16. A method of providing a radiation beam, comprising:
generating radiation with a radiation source;
emitting the radiation beam through an aperture;
collecting radiation generated by the source with a radiation collector, and transmitting the collected radiation to the aperture; and
enhancing a spectral purity of the radiation with a spectral purity filter,
wherein the filter diffracts at least part of undesired radiation, over a predetermined diffraction angle, to substantially prevent the part of undesired radiation to reach the aperture.

17. The method according to claim 16, wherein the filter has a plane of incidence that is tilted with respect to an optical transmission axis of the radiation beam emitted through the aperture.

18. The method according to claim 14, wherein the source is a laser produced plasma source comprising a radiation source that is configured to focus a beam of coherent radiation, of a predetermined wavelength, onto a fuel, wherein the spectral purity filter filters at least part of the coherent laser radiation from the radiation generated by the source.

19. A radiation system configured to generate a radiation beam, the radiation system comprising a chamber including: a radiation source configured to generate radiation; a radiation beam emission aperture; a radiation collector configured to collect radiation generated by the source, and to transmit the collected radiation to the radiation beam emission aperture; and a spectral purity filter configured to enhance a spectral purity of the radiation to be emitted via the aperture, wherein the spectral purity filter is configured to divide the chamber into a first pressure region and a second pressure region.

20. The system according to claim 19, wherein the first pressure region has a pressure greater than about 100 Pa and the second pressure region has a pressure lower than about 20 Pa.
